(19) United States
(12) Patent Application Publication
(10) Pub. No.: US 2008/0288352 A1
(43) Pub. Date: Nov. 20, 2008

(54) Method and apparatus for interactive individualized gifting and method for feedback of receipt of same

(76) Inventor: Jeffrey B. Fogel, Long Beach, NY (US)

Correspondence Address: THE FARRELL LAW FIRM, P.C., 333 EARLE OVINGTON BOULEVARD, SUITE 701, UNIONDALE, NY, 11553, US

(21) Appl. No.: 12/152,340

(22) Filed: May 14, 2008

Related U.S. Application Data
(60) Provisional application No. 60/930,142, filed on May 14, 2007.

(51) Int. Cl. G06Q 30/00

(52) U.S. Cl. 705/14

(57) ABSTRACT

Disclosed is a convenient and effectively immediate gifting method for who wants to interactively gift via a service provider by specific identification of a gift recipient, choosing a gift from among gifts available from the service provider or a partner thereof, and providing a message for relaying to the gift recipient. When the recipient accesses the service provider a gift notification is presented, allowing the recipient to redeem the gift and access the gift.

### PRIORITY

This application claims priority to provisional application Ser. No. 60/930,142 filed with the U.S. Patent and Trademark Office on May 14, 2007, the contents of which are incorporated herein by reference.

### BACKGROUND OF THE INVENTION

1. Field of Invention

The present invention relates to a system and method for interactive gifting and, in particular, to a method of sending cards and gifts via cablegrams.

2. Description of the Related Art

Television and movie viewing is a hugely popular form of leisure activity. To enhance their television and movie viewing, millions of people willingly incur a monthly charge for cable and/or satellite service. Such cable network and satellite television providers allow certain subscribers to purchase movies over their respective cable and satellite networks from a library of shows and movies licensed by the cable service provider.

Apple Inc., which designs, manufactures and markets personal computers, portable digital music players, and mobile communication devices, provides an Itunes® service that allows users to purchase movies over the Internet, i.e. on-line. These movies can be gifted locally for convenient viewing on a portable device, on a computer or on a television with the addition of dedicated hardware.

Often, while viewing a television program, a viewer will recall and seek to acknowledge an event such as a birthday or anniversary. Conventionally, a person utilizes a card and/or gift for such acknowledgment. Such cards are typically delivered by hand, regular mail or email. However, such conventional greetings and acknowledgement is typically subject to delay. Moreover, gifts, even those of significant value, rarely include as part of the gift other than the card any indication that specifically reminds the recipient of the person who gave the gift. Also, to a lesser extent, a conventional gift will lack a mechanism linking the gift to the event for which the gift was given.

The present invention overcomes such shortcomings of conventional methods by providing a unique and convenient method of sending good wishes via a television cable box interface and television/video monitor, without the need for a separate computer interface. Moreover, the present invention provides a mechanism for instantaneous delivery as well as repetitive use and acknowledgement.

### SUMMARY OF THE INVENTION

The present invention overcomes disadvantages of conventional systems by providing a method for convenient sending of good wishes via a user's television/video monitor, allowing a user to act on a sudden desire to send a token of good wishes and/or gift, allowing for specific recognition of a special and/and planned occasion.

In the present invention, a system and method are provided for interactive gifting by sending cards with a viewing gift via cablegrams that is personalized to the recipient. The present invention provides people an opportunity to discuss movies and shows that they have all viewed and enjoyed, thereby enhancing a shared experience. The present invention further provides a prompt at the conclusion of the user's movie viewing, allowing immediate selection of the previously viewed movie for gifting. The present invention provides a convenience of purchase at home, or other location where the user is recreating, of unique, personalized gifts.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a flowchart showing an input mechanism for a gifting method of the present invention:

FIG. 2 is a flowchart showing event input and acknowledgement of the present invention; and

FIG. 3 is a flowchart showing recipient operation of the present invention.

### DETAILED DESCRIPTION OF THE PREFERRED EMBODIMENTS

The following detailed description of preferred embodiments of the invention will be made in reference to the accompanying drawings. In describing the invention, explanation about related functions or constructions known in the art are omitted for the sake of clearness in understanding the concept of the invention, to avoid obscuring the invention with unnecessary detail.

As used here, a cablegram is a message for a service provider to relay to a gift recipient via the service network provided by the service provider, i.e. via cable, Internet or satellite television service. For clarity, the following description makes reference to service provider and will be recognized to also apply to services of Internet, satellite and other service providers.

In a preferred embodiment, purchaser 160 selects and sends a gift 100 to recipient 130 by accessing a service provider 110 and identifying a recipient household 120. The service provider can be a cable network provider 112 or a satellite television provider 114. The gift can be a movie 102 or other interactive service available from service provider 110 or, as described below, a partnered service provider 210.

Purchaser 160 chooses the gift from among gifts available 105 from the service provider 110. Purchaser 160 provides the service provider 110 with a message 200 to relay to the recipient 130. Recipient 130 accesses services provided by the service provider 110, at which time the service provide 110 provides to the recipient 130 notification of the gift 100. If recipient 130 elects to redeem the gift 100, the gift 100 is made available to the recipient 130. In a preferred embodiment, the service provider 110 sends a gift receipt 150 to the purchaser 160 acknowledging viewing of the gift 100. Recipient 130 is preferably provided with an interface 170 for entry of a thank you 172 for the gift 100. In a preferred embodiment, the recipient 130 can use the interface 170 to select a preformatted card 174 as the thank you 172.

In another preferred embodiment, the purchaser 160 can identify a gift delivery parameter 140 such as whether the gift 100 is to be made available for a single viewing by the recipient 130, or if the recipient 130 can store/access the gift 100 on several occasions. Upon viewing of the gift 100, a banner 180 chosen or developed by the purchaser is displayed on the viewing screen as an accompaniment of the gift 100 during viewing. The banner 180 may appears one or more times while the recipient 130 accesses the gift 100, pursuant to the purchaser's election. The banner 180 may also appear as an intermittent streamed message. Preferably, the banner 180 is presented to the purchaser 160 in a predefined format, for example, reading “Happy Birthday from Grandpa Jeff,” in a personalized manner to specifically identify the purchaser 160.

Where the recipient household 120 subscribes to a partnered service provider 210 different from but having entered into a prior agreement with the service provider 110, the available gifts 105 can include movies 102 licensed by the partnered service provider 210, but not available from the service provider 110.

In a preferred embodiment of the present invention, a purchaser 160, i.e. a person desiring to give a gift to another, if already a cable service provider customer, would order a gift 100 utilizing a remote control device 116 provided by the service provider 110. Remote control device 116 preferably is the same remote used to access other features provided by service provider 110. Billing for gift 100 is preferably reflected on the purchaser's cable service account or can alternately be charged to a credit card.

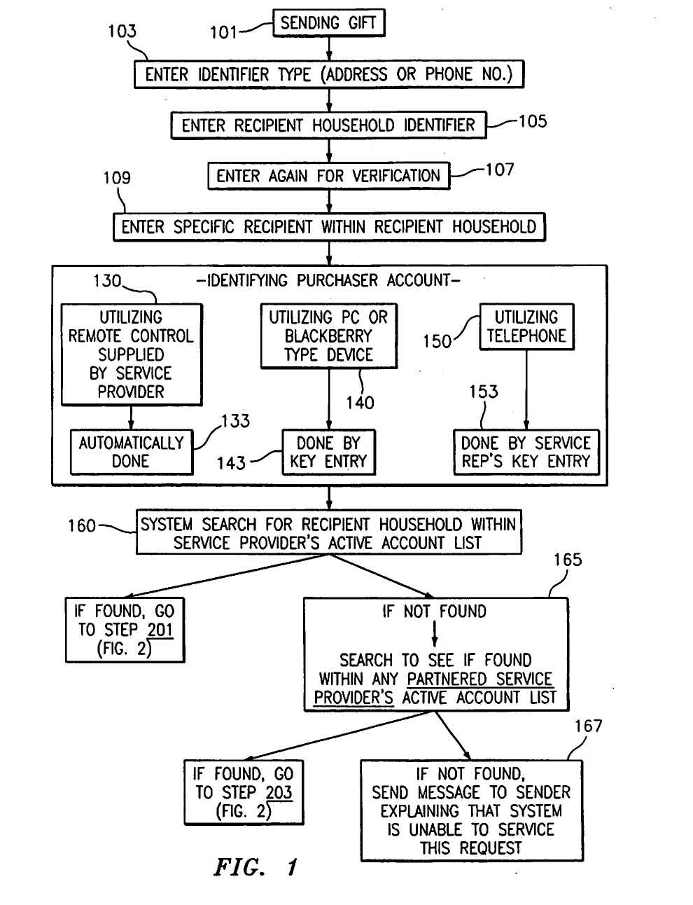

As shown in FIG. 1, at step 101 a “sending gift” option is accessed within an input menu. If the option is selected, in step 103 the purchaser 160 enters an identifier type such as a telephone number or address. In step 105, the recipient household identifier is entered. Preferably, verification is performed, such as by look-up table or repeated data entry, as shown in step 107. In step 109, the purchaser is prompted to enter the name of a specific recipient 130, particularly if there more than one person resides in the recipient household 120. A given name, nickname, or the like can be entered. Data entry can be performed via an interactive program, by selecting letters and spaces on a television screen, by keypad entry using a dedicated device, or wireless phone.

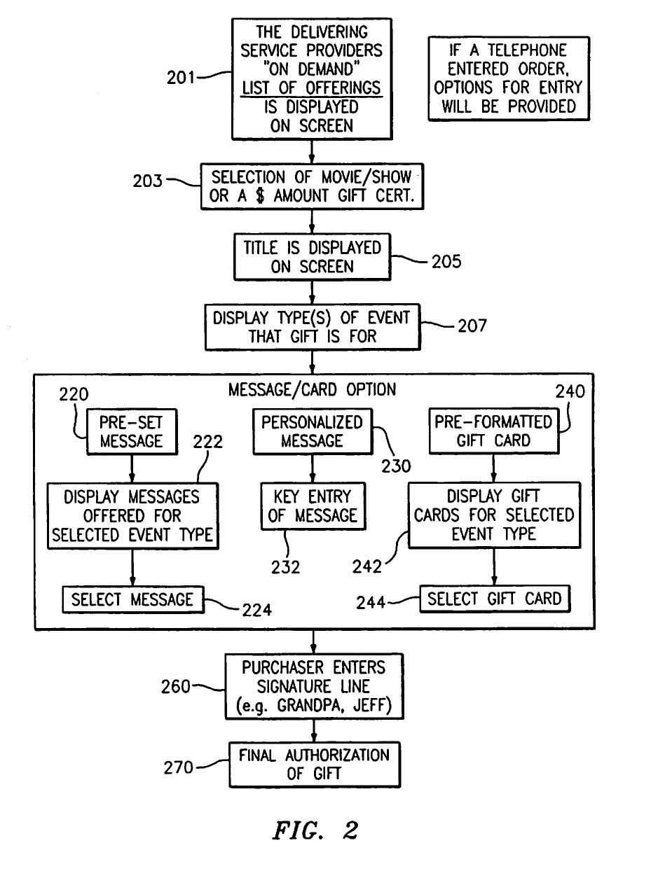

In a preferred embodiment, a prompt is provided for purchaser to utilize his or her billing name as the gift purchaser 160. At steps 130 and 133 a remote control 116 is used for automated entry. Alternatively, steps 140 and 143 depicts a key entry via a Blackberry® type device, and steps 150 and 153 depict data entry via telephone. At step 160 a system search is performed to identify the recipient household 120 within an account list of the service provider 110. If found, the process continues at step 201 of FIG. 2. If not found, a further search is performed of account lists of one or more partnered service providers 210, at step 165. If not found, a message is sent explaining that the request can not be processed, at step 167.

At step 201 of FIG. 2, a delivering service provider, i.e. the service provider 110 and/or partner service provider 210, lists the available gifts 100. A selection is made at step 203, and at step 205 a title is displayed on the screen. Although not shown in FIG. 2, multiple items can be listed and gifted. Alternatively, a dollar amount for a gift certificate can be designated, to appear as a credit on the recipient's account.

At step 207 an interface is provided for the purchaser to select among events that correspond to the gift-giving event. A message/card option is then provided. At step 220 the user is provided with choices among preformatted messages and at step 222 a display is provided of messages offered that correspond to the event type. At step 224, purchaser 160 selects a desired message 190. In a preferred embodiment, a surcharge is typically added and profits from the surcharge are split with the supplier of any pre-printed greeting card that might be used. In another preferred embodiment, the system screens for select words, thereby eliminating any obscene or offensive messages, absent prior consent of same from recipients or coordinating with recipient V-chip setting.

Alternatively, at steps 230 to 232 a personalized message can be key entered or, at steps 240 to 244 a preformatted gift card can be selected. A preferred embodiment includes a banner 180 option for displaying the desired message 190. At step 260, purchaser 160 enters an identifier such as a signature, e.g. “Grandpa Jeff”, to accompany the desired message 190, and a final authorization is made at step 270.

Although not shown in FIGS. 1 and 2, in a preferred embodiment, two warnings/disclaimers are displayed, one to the purchaser that there is no guarantee of personal delivery within the receiving household, and another, which is a privacy disclaimer, that as to the message being sent may be read by others within the receiving household.

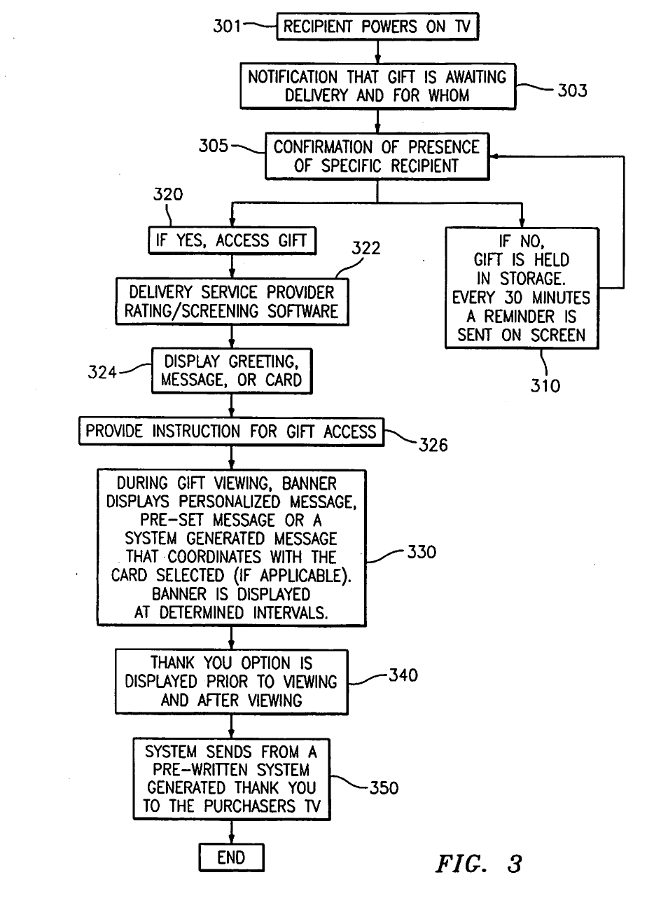

As shown in FIG. 3, when the recipient powers on their television at step 301 and accesses their cable service, a message appears showing that gift 100 is available, in step 303. At step 305, confirmation is made that the desired recipient 130 is present. If the intended gift recipient 310 is not present, at step 310 the gift is retained. Preferably, for time-sensitive gifts such as birthday greeting, a prompt is provided at regular intervals to quickly determine when recipient 130 starts viewing the television.

If recipient 130 is present, at step 320 the gift is accessed and at step 322 a provider rating service is performed, such as parental overrides to ensure viewing of only appropriate gifts within each household.

At steps 324 and 326, message 190 is displayed to the recipient 130 with access instructions. This, or at least a reminder message of “more gifts to open”, preferably repeats every time the service is accessed or until the entire gift is utilized. If a gift certificate was provided, the recipient 130 is directed to an On-Demand type selection menu to select a gift 100 to the liking of the recipient 130.

In step 330, at preset intervals during viewing of the gift, a ribbon line at the bottom of the screen appears identifying the purchaser and identifying the gift occasion. For example, a banner 180 is provided that reads: “Hope you are enjoying this show. Love, Grandma & Grandpa.” As another example, banner 180 reads: “feel better soon” for a gift provided to a sick person, with the “feel better” banner preferably being set to expire after a time corresponding to a type of illness that can be specified by the purchaser. In this embodiment, the “feel better” banner is replaced by a default banner after the passage of a default period of time, with the default banner preferably displaying a message in smaller characters and playing only on commencement and close of viewing, to identify the person or entity providing the gift.

At step 340, an interface is provided for recipient 130 to provide a thank you 172, which is preferably in the form of a preformatted card 174, either prior to or after viewing of the gift 100. If selected, the provider 110 sends the thank you 172, to the purchaser 170, at step 350.

While the invention has been shown and described with reference to certain exemplary embodiments of the present invention thereof, it will be understood by those skilled in the art that various changes in form and details may be made therein without departing from the spirit and scope of the present invention as defined by the appended claims and equivalents thereof.

What is claimed:

1. A method of providing a gift, the method comprising:
accessing a service provider;
identifying a recipient household;
choosing the gift from among gifts available from the service provider;
providing to the service provider a message for the service provider to relay to a recipient;
accessing, by the recipient, services provided by the service provider;
providing by the service provide to the recipient, notification of the gift;
redeeming, by the recipient, the gift; and
accessing, by the recipient, the gift.

2. The method of claim 1, wherein the service provider is one of a cable network provider and satellite television provider.

3. The method of claim 1, wherein the gift is one of a movie and television show.

4. The method of claim 1, further comprising setting a gift delivery parameter.

5. The method of claim 4, wherein the parameter restricts viewing of the gift to select times.

6. The method of claim 1, further comprising the service provider sending a gift receipt to a purchaser.

7. The method of claim 1, further comprising the service provider providing an interface for entry of a thank you for the gift, wherein the thank you is transmitted by the service provider to the purchaser.

8. The method of claim 1, further comprising selecting by the recipient a preformatted card as the thank you.

9. The method of claim 1, further comprising choosing a banner to accompany the gift.

10. The method of claim 9, wherein the banner appears one or more times while the recipient accesses the gift.

11. The method of claim 9, wherein the banner appears as an intermittent streamed message.

12. The method of claim 9, wherein the banner is presented to the purchaser in a predefined format.

13. The method of claim 9, wherein the banner is personalized to identify the purchaser.

14. The method of claim 1, wherein the recipient household subscribed to a partnered service provider of the service provider.

15. The method of claim 14, wherein the available gifts include one of a movie and show licensed by the partnered service provider.
